(19) United States
(12) Patent Application Publication
(10) Pub. No.: US 2010/0308510 A1
(43) Pub. Date: Dec. 9, 2010

(54) DEVICE FOR CURING PLASTIC LINERS USED FOR REHABILITATING DUCTS

(76) Inventor: Thomas Reutemann, Kempten (DE)

Correspondence Address: COLLARD & ROE, P.C., 1077 NORTHERN BOULEVARD, ROSLYN, NY, 11576, US

(21) Appl. No.: 12/734,461

(22) PCT Filed: Jan. 14, 2008
(86) PCT No.: PCT/EP2008/050327

§ 371 Date: Aug. 18, 2010

(30) Foreign Application Priority Data
Nov. 4, 2007 (DE) 10 2007 052915.7

(51) Int. Cl. B29C 73/00; H04N 7/18; B29C 35/08

(52) U.S. Cl. 264/448; 348/84; 425/174.4; 348/E07.085

(57) ABSTRACT

Device (1) for hardening plastics material liners for conduit refurbishment, with at least one ultraviolet light source (2), wherein rollers (10) for mounting the device (1) in the conduit pipe and a video camera (4) are provided and wherein a pulling device (3) by which the device is pulled through the conduit pipe to be refurbished is provided, wherein a ring (5), which is equipped with light-emitting diodes or the like, for illuminating the pipe in the recording region of the video camera (4) is provided.

The invention relates to a device for hardening plastics material liners for conduit refurbishment, with at least one ultraviolet light source, wherein rollers for mounting the device in the conduit pipe and a video camera are provided and wherein a pulling device by which the device is pulled through the conduit pipe to be refurbished is provided.

Devices of that kind are known from the state of the art.

However, all these known devices have several significant disadvantages. On the one hand, the necessary precise checking of the hardened plastics material liner is possible only with limitations particularly in the case of larger pipe diameters, since sufficient lighting of the camera viewing field cannot be guaranteed.

On the other hand, the problem is also present that it cannot be checked how the device moves forward in the pipe and which state the liner has prior to hardening.

In addition, there is the problem that an inaccurate analysis of the recorded camera images is possible only with difficulty, since these cannot be referenced.

Furthermore, the known devices are very inflexible. They are either suitable for larger pipe diameters and larger lengths or, however, for smaller pipe diameters and shorter lengths.

It is the object of the invention to overcome the stated disadvantages and to propose a flexibly usable device, the use of which is also understandable at any time and able to be documented.

This object is fulfilled by the characterising features of the main claim, also able to be enhanced by the subclaims.

It has proved very advantageous if a ring, which is equipped with light-emitting diodes or the like, for illuminating the pipe is provided in the recording region of the video camera.

The video camera can be directed against the direction of pulling. Two or more rows, which are arranged adjacent to one another, of light-emitting diodes, preferably three or more rows, for illuminating the pipe can be provided, wherein the respective rows can be arranged at an angle to the longitudinal axis of the device. The angles of the individual rows can be different from one another. It has proved very advantageous if one row of light-emitting diodes has an angle of 90° to the pulling direction. Equally, it is very advantageous if one row of light-emitting diodes has an angle of 110° to the pulling direction. Moreover, it is very advantageous if one row of light-emitting diodes has an angle of 120° to 125° to the pulling direction. A combination of these three rows gives, with these orientations, very good illumination of the recording field of the camera not only with small pipe diameters, but also with large pipe diameters.

The video camera should, just like the ring of light-emitting diodes or the like, be constructed to be heat resistant up to at least 120° C.

The video camera preferably has an aperture angle for recording of between 130 and 150°.

A further camera which is oriented in pulling direction can be provided.

In that case the second camera is to be constructed in miniature mode of construction and to have a diameter of at most 25 millimetres.

The first and second cameras shall be constructed to be heat resistant up to at least 120° C.

Moreover, at least one item of equipment for position recognition can be provided, which can also be constructed as a rotation transmitter.

This equipment for position recognition shall similarly be constructed to be heat resistant up to 120° C.

In addition, at least one sensor for scanning the pipe inner side can be provided, wherein, however, it is very advantageous if several sensors are arranged uniformly at the circumference of the device. It has proved particularly advantageous if three sensors are provided. The sensors can be constructed as infrared sensors and shall be heat resistant up to at least 120° C.

The light source, cameras and sensors are connected with a control unit, wherein the control unit can be of modular construction.

In that case the control unit comprises at least one module for activation of an ultraviolet light source. Several modules for activation of ultraviolet light sources with different power can also be provided. The modules themselves can, for activation of an ultraviolet light source, have a regulable output.

Moreover, a registration module for registration of process parameters and/or images and/or videos can be provided.

A control module can be provided for activation and controlling of all parts of the control unit.

The connection between light source, cameras, sensors and control unit can be constructed as a CAN bus. The second camera can be constructed to be switchable over to the camera signal of the first camera by way of a switching-over unit, preferably of heat-resistant construction.

The cable connection between light source, cameras, sensors and control unit can be constructed to be exchangeable.

For a method for conduit pipe refurbishment with use of the device according to the invention it has proved very advantageous if a plastics material liner is introduced into a conduit pipe and subsequently hardened by the device through ultraviolet radiation, wherein the process parameters are monitored during the hardening, the hardening temperatures are recorded by way of infrared sensors and the positions of the device in the pipe are determined and recorded.

In addition, the liner can be monitored by way of the first camera after the hardening, wherein the recording field of the camera is illuminated by way of the lighting ring.

The liner can be monitored by way of the second camera prior to the hardening.

The recorded parameters can be registered and correlated with one another.

The camera images can be correlated with the position determination and thus matched in correspondence with the pipe position.

The widening of the aperture angle of the optical system of the first video camera from the previous 90° to now 145° also enables detection of pipes with a diameter of up to 1200 millimetres or even more. As a result, for the first time the refurbishment of even large conduit pipes of that kind by drawing in a liner and hardening thereof by ultraviolet light is possible.

In order to now be able to recognise possible liner defects in the viewing field of the first video camera the viewing field has to be lit. This is not possible with the known lighting systems. Uniform illumination cannot be achieved. In order to now solve this consequential problem use is made—as already stated—of a lighting ring of very bright light-emitting diodes. These ensure uniform and sufficiently bright illumination. In the case of different pipe diameters the light-emitting diodes would have to be respectively differently oriented in order to achieve the intended and desired illumination in the relevant region. Consequently, in accordance with the invention use of a multiple ring is proposed in which the light-emitting diodes of the individual rings have respectively different orientations.

For better monitoring of the hardening process and also for better orientation in the pipe a second camera directed in pulling direction of the device can be provided. This camera is of miniature construction and has a diameter of at most 25 millimetres.

The second camera can be switched by means of a switching-over device to the camera signal of the first camera so that transmission channels, thus wires of the cable connection, are saved particularly in the case of analog transmission to the control unit.

The progress of the hardening is detected by way of sensors. Since the hardening elapses as an exothermic polymerisation use can be made of temperature sensors, preferably infrared temperature sensors. These are uniformly distributed over the circumference of the device. Since temperature sensors of that kind always detect and return a mean value from the detection range and the detection range is very dependent on the distance between sensor and surface to be measured, it is possible to detect values very much capable of misunderstanding. This is due to the fact that the device is not pulled centrally through the pipe. A complete matching to the pipe diameter is not possible, since then the device can no longer be pulled through due to irregularities in the pipe. Accordingly, the device always lies deeper than the pipe centre point. In addition, the problem exists that in the past it could not be guaranteed which orientation the device had in the pipe interior. In addition, the pipe can rotate about its longitudinal axis when being pulled through.

Since the pipe inner diameter and also the diameter and the position of the device and thus of the temperature sensors are known, the ascertained values of the sensors can be placed even better in relationship, evaluated and interpreted.

Due to these imponderables the recorded values can be interpreted only with difficulty. In order to counteract this part problem a rotation transmitter is provided by way of which the orientation of the device in the pipe can be ascertained. With this information, the recorded temperature data and also the video images can be matched to an artificial horizon. The data and images are then very readily understandable and comprehensible.

In order to improve the data transmission between control unit and device use is proposed in accordance with the invention of a CAN bus. This employs a serial transmission method which can be secured by additional parity data and thus is very much insusceptible to disturbance by comparison with analog transmission methods. Thus, not only greater transmission lengths are made possible, but also more data can be transmitted. It is thus conceivable that the video images of first and second cameras are transmitted simultaneously. The temperature data and the position information are transmitted at the same time. In addition, further data about the travel path already covered or also monitoring data for the ultraviolet lamps can be transmitted.

All components of the device are to be constructed to be heat resistant up to 120° C. so that these withstand without damage the temperatures arising during hardening. Precision parts, in particular, have to be made from special heat-resistant materials so that these do not significantly change their shape or size.

The control unit can be of modular construction and have one or more modules for activation of ultraviolet lamps. In addition, a registration module for images and further data with respect to time or pipe position can be provided. The device is controlled by way of a control module.

The device and the control unit can be connected together by way of different cables so that different lengths can be realised. In addition, devices with different forms of lamp equipment can be connected.

In the performance of the method a plastics material liner is introduced into a conduit pipe and subsequently hardened by the device through ultraviolet radiation, wherein the process parameters during the hardening are monitored, the hardening temperatures are recorded by way of infrared sensors and the positions of the device in the pipe determined and recorded.

Through this recording it is possible on the one hand not only to log the internal pressure, air and surface temperatures, speeds, paths traveled, time, triggered radiators, video images, outputs of the triggered radiators, horizontal and vertical positions of the device and/or ultraviolet intensity, but also to bring all these parameters into relationship with one another. Thus, it is conceivable that the real time video images can be interrogated with respect to the pipe length at any pipe position, just as the entire relevant data. It is also conceivable that the hardening data can be interrogated in dependence on the recorded video.

The recording data can be stored, for example, by way of a video PC on a data carrier and thus submitted for documentation purposes. The proper execution of the refurbishment can be evidenced at any time.

The invention is explained in the following by way of an exemplifying embodiment.

In that case:

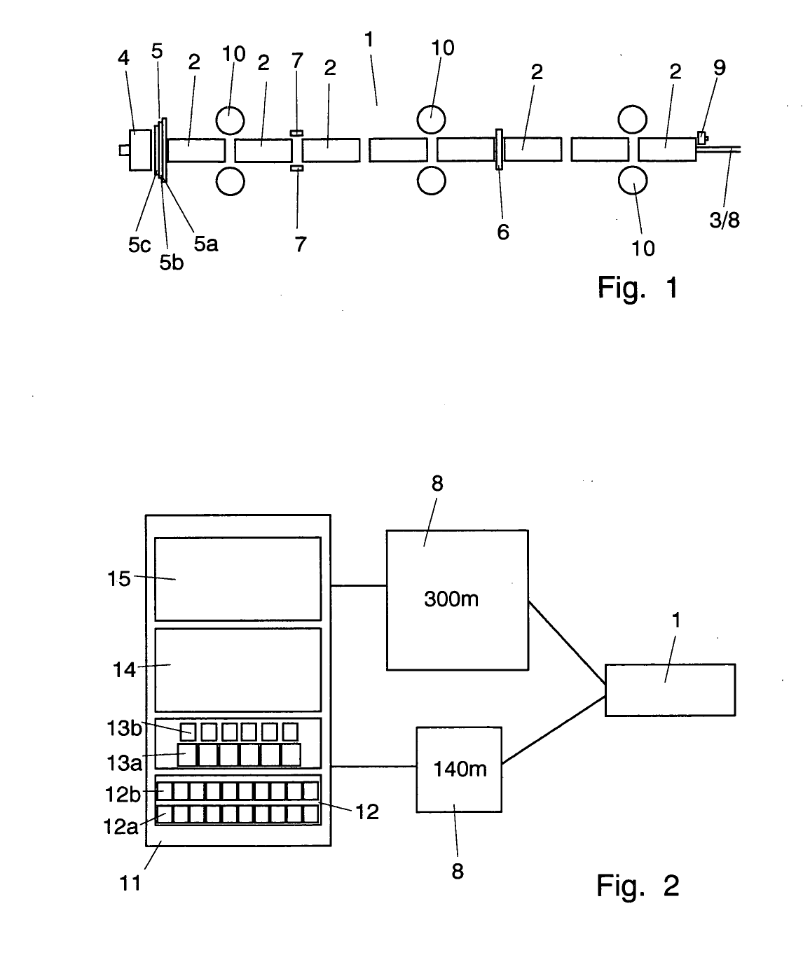

FIG. 1 shows a schematic construction of a device according to the invention for hardening plastics material inner liners for conduit refurbishment, by means of ultraviolet light, and

FIG. 2 shows a schematic construction of a complete installation which contains the device and is provided with control and recording units.

A device for hardening plastics material inner liners for conduit refurbishment by means of ultraviolet light is denoted in FIG. 1 by 1. This device is provided with adjustable wheels 10 adaptable to the respective pipe diameter. The device is equipped with eight ultraviolet radiators 2 which respectively have a settable power between 400 and 650 W. The device 1 is pulled through the pipe by means of a traction cable 3. A video camera 4 which monitors the hardened liner is installed oppositely to the pulling direction defined by the traction cable 3. For this purpose the camera 4 comprises an optical system with an approximately 145° aperture angle, aperture approximately 2.0. In order to ensure the necessary illumination of the recording field of the camera 4 a triple illuminating ring 5 is provided, which is equipped with very bright light-emitting diodes. The individual diode rows 5a, 5b and 5c in that case have respectively different orientation. The diode row 5a is oriented at 90° to the pulling direction, whereagainst the diode row 5b is oriented at 110° and the diode row 5c at 125°, whereby outstanding illumination with pipe diameters between DN 150 and DN 1200 or even larger is guaranteed.

In addition, a rotation sensor 6 is provided which is capable of detecting the rotational position of the device 1 in the pipe. Three infrared sensors uniformly distributed over the circumference of the device 1 are provided for recording the hardening temperatures. However, it is also conceivable to provide further sensors 7.

Further sensors, which are not illustrated, can also be provided for recording further variables.

The device 1 is controlled by way of a control unit 11. The connection between device 1 and control unit 11 is undertaken by way of a cable 8. The cable 8 can in that case be used at the same time as traction cable 3.

A second camera 9 capable of monitoring the liner before hardening thereof is installed in the direction of the traction cable 3.

The control unit 11 is of modular construction. Initially, a power module 12 for controlling and triggering the lamps is provided. This power module is in that case equipped for 10 radiators with a power respectively between 400 and 650 watts. The power module 12 then comprises an auxiliary switching apparatus 12a which undertakes the actual activation of the lamps 2. The auxiliary switching apparatus 12a is in turn controlled by a frequency converter 12b, whereby control and setting of the lamp power between 400 and 650 watts is made possible without in that case leaving the optimum working range of the lamps 2. This relatively weak power module 12 is provided for drive control of devices 1 which are used for refurbishing conduit pipes with a diameter of at most DN 600.

In addition, a second power module 13 can be provided, which is intended for activation of 6 radiators with a power between 800 and 1200 watts. Here, too, the actual lamp control takes place by way of an auxiliary switching apparatus 13a, which is controlled by a frequency converter 13b so that the lamp power can be set to, for example, the steps 800 watts, 1000 watts or 1200 watts. Devices 1 with these lamp powers are provided for refurbishment of conduit pipes with a diameter of up to DN 1200.

The power modules 12 and 13 are controlled in drive by a control module 14.

In addition, a data and video registration module 15 is provided, which is responsible for registration of the process parameters, the video images and the illustration thereof in correlation and is oriented to an artificial horizon.

All modules 12, 13, 14 and 15 are integrated together in a rack and can be exchanged in simple manner.

Cables 8 with 140 metres and with 300 metres, which are selectably usable, are provided for the cable connection between control unit 11 and device 1. The 140 metre cable 8 is wound up on a portable cable drum, whereagainst the 300 metre cable 8 is fixedly installed on a truck. The cable can be plugged in simple mode and manner not only to the power modules 11 and 12, but also to the device 1.

1-37. (canceled)

38. Device (1) for hardening plastics material liners for conduit refurbishment, with at least one ultraviolet light source (2), wherein rollers (10) for mounting the device (1) in the conduit pipe and a video camera (4) are provided and wherein a pulling device (3) by which the device is pulled through the conduit pipe to be refurbished is provided, wherein a ring (5), which is equipped with light-emitting diodes or the like, for illuminating the pipe in the recording region of the video camera (4) is provided, whereby the video camera (4) can be oriented oppositely to the pulling direction and/or wherein two or more rows (5a, 5b, 5c), which are arranged adjacent to one another, of light-emitting diodes, preferably three or more rows, for illuminating the pipe are provided, whereby the respective rows (5a, 5b, 5c) can be arranged at an angle to the longitudinal axis of the device (1) and wherein the angles of the individual rows (5a, 5b, 5c) can differ from one another, whereby a row (5a) of light-emitting diodes can have an angle of 90° to the pulling direction and/or one row (5b) of light-emitting diodes can have an angle of 110° to the pulling direction and/or one row (5c) of light-emitting diodes can have an angle of 120° to 125° to the pulling direction.

39. Device according to claim 38, wherein the video camera (4) and/or the ring (5) of light-emitting diodes or the like is constructed to be heat-resistant up to at least 120° C.

40. Device according to claim 38, wherein the video camera (4) has an aperture angle for the recording of between 130° and 150°.

41. Device according to claim 38, wherein a further camera (9) oriented in pulling direction is provided, whereby the second camera (9) can be of miniature construction and can have a diameter of at most 25 millimeters and whereby the second camera (9) can be constructed to be heat resistant up to at least 120° C.

42. Device according to claim 38, wherein at least one item of equipment (6) for position recognition is provided, whereby at least one rotation transmitter (6) can be provided and whereby the equipment (6) for position recognition can be constructed to be heat resistant up to at least 120° C.

43. Device according to claim 38, wherein at least one sensor (7) for scanning the pipe inner side is provided, whereby several sensors (7) can be arranged uniformly at the circumference of the device and whereby infrared sensors can be provided as sensors (7) for the scanning and whereby the sensors (7) are constructed to be heat resistant up to at least 120° C.

44. Device according to claim 43, wherein three sensors (7) are provided.

45. Device according to claim 38, wherein the light source (2), cameras (4, 9) and sensors (6, 7) are connected with a control unit (11), whereby the connection between light source, cameras, sensors and control unit can be constructed as a CAN bus and/or the cable connection (8) between light source (2), cameras (4, 9), sensors (6, 7) and control unit (11) can be constructed as an exchangeable cable connection (8), and whereby the control unit (11) can be of modular construction.

46. Device according to claim 45, wherein the control unit (11) comprises at least one module (12, 13) for activating an ultraviolet light source, whereby several modules (12, 13) for actuating ultraviolet light sources with different power can be provided and/or whereby the module (12, 13) for activating an ultraviolet light source can have a regulatable output (12a, 13a).

47. Device according to claim 45, wherein a registration module (15) for registering process parameters and/or images and/or videos is provided, whereby a control module (14) for activation and controlling all parts of the control unit can be provided and/or wherein the second camera (9) can be constructed to be switchable over to the camera signal of the first camera (4) by way of a switching-over unit preferably of heat-resistant construction.

48. Method for conduit pipe refurbishment by a device according to claim 38, wherein a plastics material liner is introduced into a conduit pipe and subsequently hardened by the device by ultraviolet radiation, wherein the process Parameters during the hardening are monitored, the hardening temperatures are recorded by way of infrared sensors (7) and the positions of the device (1) in the pipe are determined and recorded.

49. Method according to claim 48, wherein the liner is monitored by way of the first camera (4) after the hardening, wherein the recording field of the camera (4) is illuminated by way of the lighting ring (5).

50. Method according to claim 48, wherein the liner is monitored by way of the second camera (9) prior to the hardening.

51. Method according to claim 48, wherein the recorded parameters are registered and correlated with one another.

52. Method according to claim 48, wherein the camera images and/or the sensor data are correlated with the position determination and the data are then indicated in correspondence with the pipe position.
